(19) United States
(12) Patent Application Publication
(10) Pub. No.: US 2011/0016052 A1
(43) Pub. Date: Jan. 20, 2011

(54) Event Tracking and Velocity Fraud Rules for Financial Transactions

(76) Inventor: Ernest M. Scragg, Loveland, CO (US)

Correspondence Address: TOWNSEND AND TOWNSEND CREW LLP, TWO EMBARCADERO CENTER, 8TH FLOOR, SAN FRANCISCO, CA, 94111, US

(21) Appl. No.: 12/835,564

(22) Filed: Jul. 13, 2010

Related U.S. Application Data
(60) Provisional application No. 61/226,232, filed on Jul. 16, 2009.

(51) Int. Cl. G06Q 20/00; G06Q 40/00

(52) U.S. Cl. 705/44

(57) ABSTRACT

A fraud rule can be applied to a transaction according to a first authorization parameter. The transaction is passed to a filtering rule which is applied to the transaction according to a second authorization parameter. The filtering rule can approve the transaction for processing or pass the transaction on to a third party analysis. The fraud and filtering rules can apply the same analysis to the transaction with the exception of the authorization parameters. The fraud rule and filtering rules can analyze historical attributes of a consumer account.

### CROSS-REFERENCES TO RELATED APPLICATIONS

This application claims the benefit of U.S. Provisional Patent Application No. 61/226,232, filed on Jul. 16, 2009, the entirety of which is incorporated herein by reference.

### BACKGROUND

Fraudulent transactions regarding credit cards and/or other similar payment mechanisms, such as debit cards, may result in huge losses. Criminals have learned to exploit gaps in conventional fraud detection techniques available to card issuers and the payment processing networks that process transactions for card issuers. Conventional fraud detection techniques may be too strict in some instances, resulting in legitimate transactions being declined, and a resulting loss of revenue. Conventional fraud detection techniques may also be too lenient in some instances, resulting in fraudulent transactions being processed.

Conventional fraud prevention techniques can include loopholes which criminals can exploit. For example, banks often make at least a portion of an ATM deposit immediately available for withdrawal even though a check associated with the transaction has not been cleared by the bank. Criminals exploit this vulnerability by making a series of ATM deposits with bad checks to falsely load an account over a short period of time, and then withdraw the available funds resulting from the fraudulent deposits. Each deposit is small enough to not alert conventional fraud rules, and when aggregated provide a large amount of funds available for withdrawal.

Third party fraud detection platforms (i.e., outside of the standard authorization platform), such as the Falcon® system by Fair Isaac Corp., are available to apply a very high level of fraud detection via neural networking and complex statistical models. However, the time and cost for employing these detection platforms can be exceedingly high, especially when aggregated. Thus, use of such third party platforms is typically only reserved for transactions of the highest risk. Accordingly, conventional fraud techniques are ineffective for many issuers, while third party systems are overly complex and do not provide a justifiable cost to benefit ratio.

Embodiments of the invention address these and other problems, individually and collectively.

### BRIEF SUMMARY

Layered fraud rules which analyze historical transaction data are disclosed.

Embodiments of the invention include the use of rules which use historically tracked transaction information to make authorization determinations. A fraud detection system can implement two layers of rule implementation (i.e., flash fraud rules and real time filtering) for real-time transaction fraud detection. Three aspects of each rule can include velocity counts, transaction amounts, and the number of times a particular transaction occurs, all of which can be stored on a cardholder database. The rules and aspects can be configured by an issuer.

As an illustration, the invention relates to the use of transaction events (e.g., on-line type of transaction), velocity counts (e.g., fifteen transactions in one hour), and amounts over specified time intervals (e.g., $10,000 in one hour) as parameters that can be used to filter out transactions for decline before the transaction message is sent to a third-party scoring engine such as Falcon. The invention uses two layers of rule processing, which results in fewer authorization requests sent to a fraud detection platform such as Falcon®, as compared to a single rule system. This has the effect of reducing third-party processing fees and processing time.

One embodiment of the invention provides a method for processing a transaction. A payment request may be received to approve a transaction associated with a consumer account at a server computer. The payment request may be a request to authorize a transaction such as a payment transaction. The payment request may be embodied by an authorization request message. At least one fraud rule may be applied according to a first authorization parameter to the transaction, using the server computer. The payment request may be passed to at least one filtering rule based on approval of the at least one fraud rule, using the server computer. The at least one filtering rule may be applied according to a second authorization parameter to the transaction, using the server computer. The payment request may be approved or passed to a third-party fraud analysis based on the application of the least one filtering rule, using the server computer. The at least one filtering rule may apply a transaction attribute of the one fraud rule to the second authorization parameter.

Another embodiment of the invention provides a method of generating a fraud rule for a consumer account. Transaction attributes may be defined to be applicable to at least one fraud rule and at least one filtering rule regarding a payment request, using a server computer. At least one first authorization parameter may be defined for the at least one fraud rule, for authorizing the payment request to pass to at least one filtering rule and for denying the payment request, using the server computer. At least one second authorization parameter may be defined for the at least one filtering rule, for authorizing the payment request and for passing the transaction to a third-party fraud analysis, using the server computer. The at least one filtering rule may apply at least one transaction attribute of the at least one fraud rule to the second authorization parameter.

Yet another embodiment of the invention is directed to respective computer readable mediums comprising instructions for respectively implementing the above-described methods when executed by a processor.

These and other embodiments of the invention are described in further detail below.

### BRIEF DESCRIPTION OF THE DRAWINGS

FIG. 1 is a schematic diagram of a system, for use with embodiments of the invention.

FIG. 2 is a schematic diagram of a payment processing network, according to an embodiment of the invention.

FIG. 3 is a schematic diagram of a computer system, for use with embodiments of the invention.

FIG. 4A is a flow diagram of a method for defining fraud rules, according to an embodiment of the invention.

FIG. 4B is a screen shot of a user interface for defining fraud rules, according to an embodiment of the invention.

FIG. 5 is a flow diagram of a method for implementing fraud rules, according to an embodiment of the invention.

### DETAILED DESCRIPTION

Embodiments of the invention provide flash fraud and real time filtering rules to process transactions. The flash fraud and real time filtering rules analyze velocity of historical events of a particular consumer account, or particular group of accounts. The flash fraud rules can deny a transaction or pass the transaction on to the real time filtering rules. The real time filtering rules can approve the transaction or pass the transaction on to a third party fraud detection system. The flash fraud and real time filtering rules may employ similar rules with different authorization parameters, which reduces the amount of transactions passed to the third party fraud detection system. The flash fraud and real time filtering rules may be customizable by an issuer via a user interface.

I. Exemplary System:

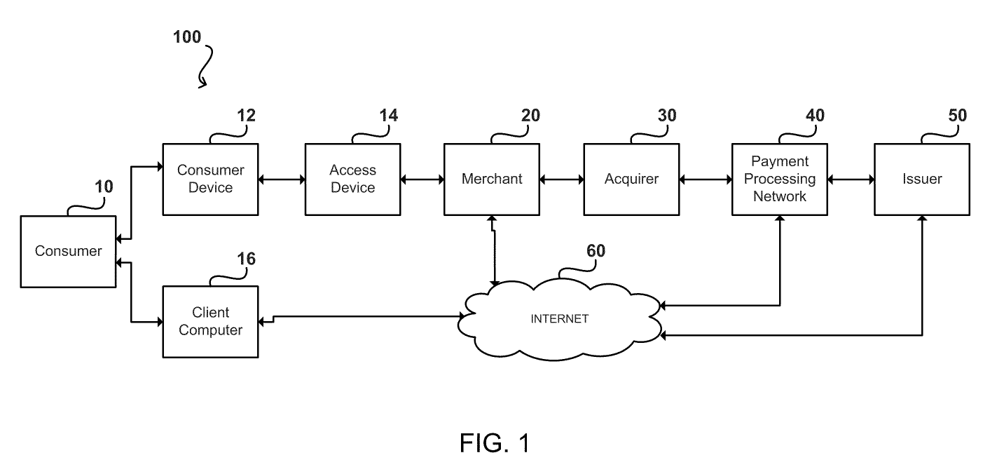

FIG. 1 shows a system 100 that can be used for conducting a payment transaction. The components in FIG. 1 may communicate via any suitable communication medium (including the internet), using any suitable communication protocol. System 100 can represent a standard payment request authorization model.

The system 100 includes a consumer 10 which may be an individual, or an organization such as a business that is capable of purchasing goods or services. The consumer 10 may operate a client computer 16. The client computer 16 can be a desktop computer, a laptop computer, a wireless phone, a personal digital assistant (PDA), etc., using any suitable operating system. The client computer may be used to interact with a merchant 20 (e.g., via a merchant website).

The consumer 10 may also be associated with a portable consumer device 12. A consumer account associated with the portable consumer device 12 may be used for purchase transactions. Embodiments of the portable consumer device 12 may be in any suitable form. For example, suitable portable consumer devices can be hand-held and compact so that they can fit into a consumer's wallet and/or pocket (e.g., pocket-sized). They may include smart cards, ordinary credit or debit cards (with a magnetic strip and without a microprocessor) such as payment cards, keychain devices (such as the Speedpass™ commercially available from Exxon-Mobil Corp.), etc. Other examples of portable consumer devices include cellular phones, personal digital assistants (PDAs), pagers, stored value cards, security cards, access cards, smart media, transponders, and the like.

The merchant 20 may be an individual or an organization such as a business that is capable of providing goods and services. The merchant 20 may have a computer apparatus. The computer apparatus may comprise a processor and a computer readable medium. The computer readable medium may comprise code or instructions for sending a transaction clearing request and receiving a clearing return code.

The merchant 20 may have one or more access devices 14. Suitable access devices 14 include interfaces and may include point of sale (POS) devices, cellular phones, PDAs, personal computers (PCs), tablet PCs, handheld specialized readers, set-top boxes, electronic cash registers (ECR), automated teller machines (ATM), virtual cash registers (VCR), kiosks, security systems, access systems, and the like. If the access device 14 is a POS terminal, any suitable POS terminal may be used and may include a reader, a processor, and a computer readable medium. A reader may include any suitable contact or contactless entry mode of operation. For example, exemplary card readers can include radio frequency (RF) antennas, optical scanners, bar code readers, magnetic stripe readers, etc. to interact with portable consumer device 12. As another alternative, a consumer 10 may purchase a good or service via a merchant's website where the consumer enters the credit card information into the client computer 16 and clicks on a button to complete the purchase. The client computer 16 may be considered an access device.

The system 100 also includes an acquirer 30 associated with the merchant 20. The acquirer 30 may be in operative communication with an issuer 50 of the consumer device 12 via a payment processing network 40. The acquirer 30 is typically a bank that has a merchant account. The issuer 50 may also be a bank, but could also be a business entity such as a retail store. Some entities are both acquirers and issuers, and embodiments of the invention include such entities. The acquirer 30 and the issuer 50 may each have a server computer and a database associated with the server computer.

The payment processing network 40 is located between (in an operational sense) the acquirer 30 and the issuer 50. It may include data processing subsystems, networks, and operations used to support and deliver authorization services, exception file services, and clearing and settlement services. For example, a payment processing network may include VisaNet™ . Payment processing networks such as VisaNet™ are able to process credit card transactions, debit card transactions, and other types of commercial transactions. VisaNet™ , in particular, includes a VIP system (Visa Integrated Payments system) which processes authorization requests and a Base II system which performs clearing and settlement services.

The payment processing network 40 may use any suitable wired or wireless network, including the Internet 60. The payment processing network 40 may have a server computer and a database associated with the server computer. The server computer may comprise a processor and a computer readable medium. The computer readable medium may comprise code or instructions for the methods disclosed herein.

For simplicity of illustration, one consumer 10, one consumer device 12, one client computer 16, one access device 14, one merchant 20, one acquirer 30, and one issuer 50 are shown. It is understood, however, that embodiments of the invention may include multiple consumers, consumer devices, client computers, access devices, merchants, acquirers, and issuers. In addition, some embodiments of the invention may include fewer than all of the components shown in FIG. 1.

In a typical transaction, an consumer 10 uses a consumer device 12 such as a payment card to interact with the access device 14 at the merchant 20. An authorization request message is generated by a processor in the access device 14 or and is sent to the payment processing network 40 via the acquirer 30. If the transaction is an online transaction, the client computer 16 can communicate with the merchant 20 via the Internet 60 and a computer at the merchant 20 can generate the authorization request message. Once received, the payment processing network 40 can perform appropriate fraud scoring and can send any fraud scores to the issuer 50 along with the authorization request message. Alternatively, the payment processing network 40 can simply deny the request of the fraud score indicates that the transaction is too risky.

If the authorization request message is approved by the issuer 50, the issuer 50 may generate an authorization response message and may sent it back to the access device 14 or the client computer 16 via the payment processing network 40 and the acquirer 30.

At the end of the day or other time, a clearing and settling process can occur.

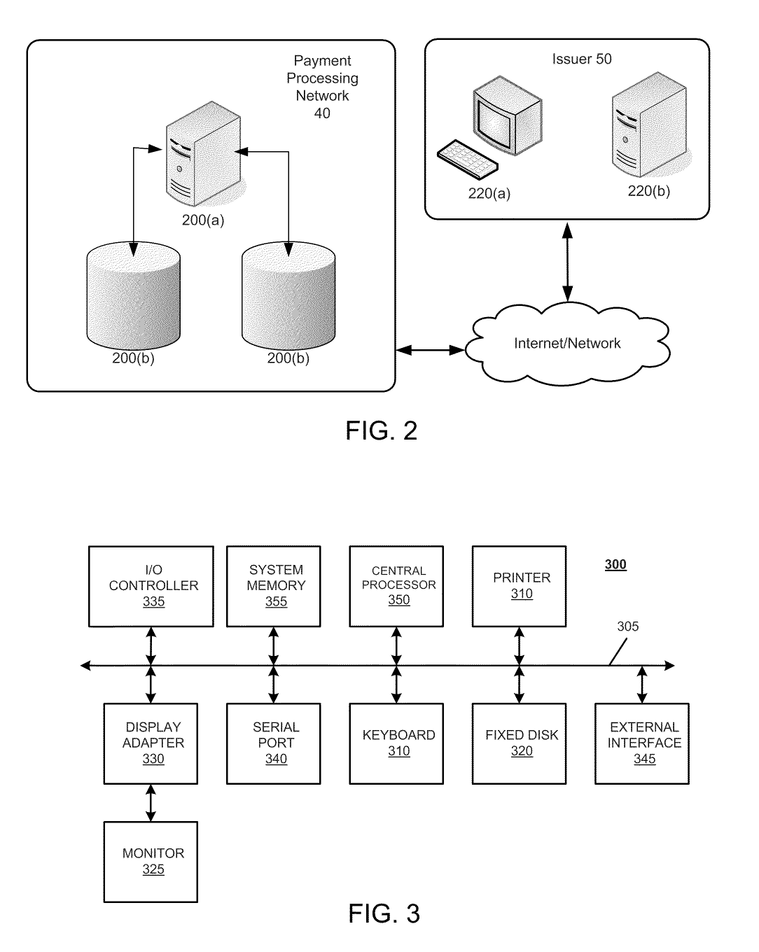

FIG. 2 is a high level block diagram of the payment processing network 40, according to an embodiment of the invention. Payment processing network 40 includes server computer 200(a), cardholder information database 200(b), and rules database 200(c). The server computer 200(a) may be a powerful computer apparatus or a cluster of computer apparatuses. For example, the server computer 200(a) can be a large mainframe, a minicomputer cluster, or a group of servers functioning as a unit. In one example, the server computer 200(a) may be a database server coupled to a Web server. The server computer 200(a) includes a computer readable medium (CRM) and a processor coupled to the CRM.

The issuer 50 may access the payment processing network 40 to update the cardholder information database 200(b) and rules database 200(c). The issuer 50 may access the databases using a user interface of a client computer 220(a) or remote server 220(b), both of which may be connected to the payment processing network 40 over the internet or through a direct network connection. The payment processing network 40 may supply one or more user interfaces to the issuer 50 for interfacing with the payment processing network 40.

The server computer 200(a) is configured to execute flash fraud rules from the rules database 200(c) against the transaction, and to execute the real time filtering rules from the rules database 200(c) against the transaction, if the transaction does not match the criteria of any of the flash fraud rules. If a transaction matches the criteria of a flash fraud rule, the server computer system 200(a) is configured to deny the transaction and to report the transaction as a fraudulent transaction. If the transaction matches the criteria of a real time filtering rule, the transaction may be subjected to additional scrutiny before making a determination whether to decline or authorize the transaction. When analyzing the transaction, the flash fraud and real time filtering rules analyze historical consumer data retrieved from the cardholder information database 200(b).

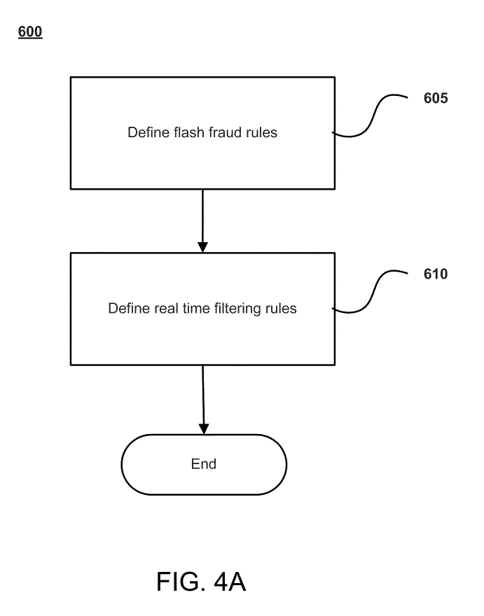

FIG. 3 is a high level block diagram of a computer apparatus 300 that may be used to implement any of the entities or components (e.g., client devices, server computers, etc.) described above, which may include one or more of the subsystems or components shown in FIG. 3. The subsystems shown in FIG. 3 are interconnected via a system bus 305. Additional subsystems such as a printer 310, keyboard 315, fixed disk 320, monitor 325, which is coupled to display adapter 330, and others are shown. Peripherals and input/output (I/O) devices, which couple to an I/O controller 335, can be connected to the computer apparatus 300 by any number of means known in the art, such as serial port 340. For example, serial port 340 or external interface 345 can be used to connect the computer apparatus 300 to a wide area network such as the internet, a mouse input device, or a scanner. The interconnection via the system bus 305 allows the central processor 350 to communicate with each subsystem and to control the execution of instructions from system memory 355 or the fixed disk 320, as well as the exchange of information between subsystems. The system memory 355 and/or the fixed disk 320 may embody a computer readable medium.

II. Flash Fraud and Real Time Filtering Rules:

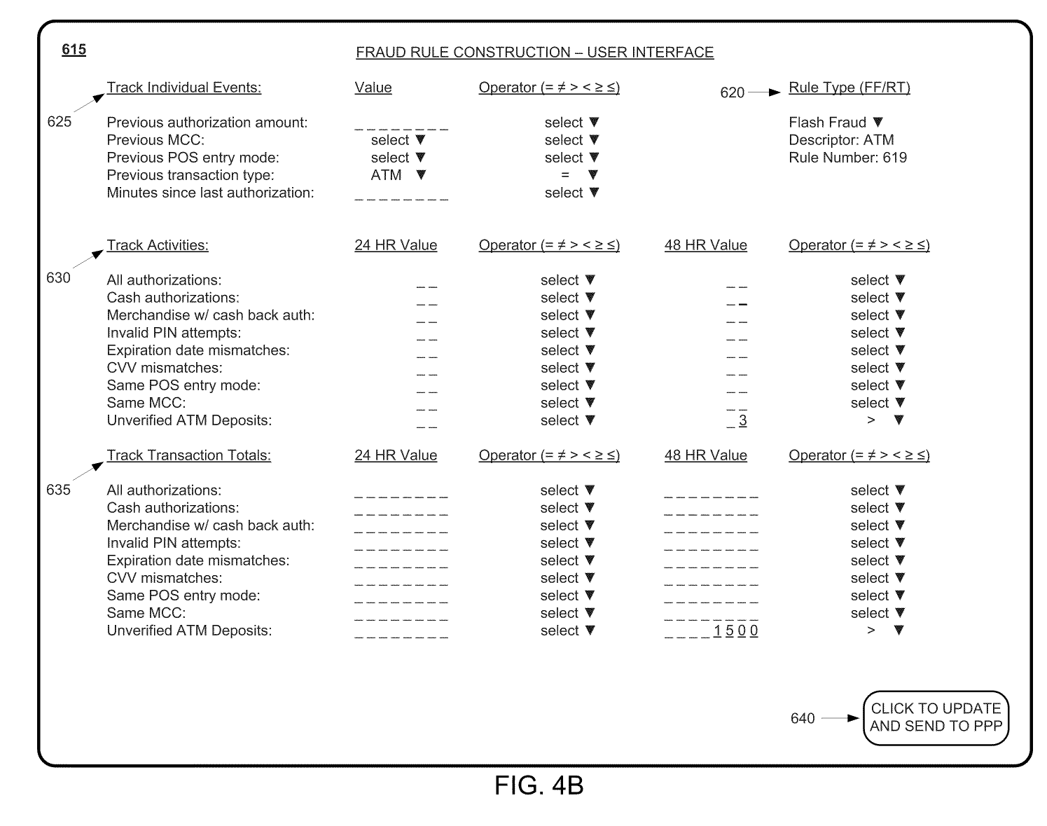

FIG. 4A shows a flow diagram of a method 600 for constructing flash fraud and real time filtering rules, according to an embodiment of the invention. In some embodiments, the flash fraud and real time filtering rules analyze consumer account velocity based on predetermined categories of historical transaction information associated with a consumer account, or particular group of accounts. The flash fraud and real time filtering rules can be configured by the issuer 50. Further, the flash fraud and real time filtering rules may exclusively analyze historical information, or additionally analyze current transaction information. Generally, the time of the current transaction will provide a reference point for analyzing historical information. The flash fraud and real time filtering rules may each apply a similar or identical analysis, but according to different authorization parameters. Particular flash fraud and real time filtering rules may be triggered by particular pre-associated risk factors of the transaction.

At step 605, flash fraud rules are defined by the server 200(a) for analyzing a payment request. The flash fraud rules can incorporate three major aspects for velocity analysis of historical transaction information.

A first flash fraud rules aspect may track individual events of a consumer account. Such events can include previous (i.e., directly proceeding from a current transaction) authorization amount, previous merchant category code (MCC), previous POS entry mode, a previous transaction type, and minutes since the last authorization (e.g., velocity). Other tracked events can include cardholder country code, cardholder postal code, merchant country code, available credit/balance, address verification results, expiration date mismatch, ATM ID, BIN, acquirer network ID, PAN entry mode, payment form factor, electronic commerce results, contactless card ATC delta, contactless card cryptogram results, and authorization request cryptogram.

Each type of individual event may regard a rule. A rule can be defined to trigger a fraud indication if the event provides a value which satisfies an operator (= ≠ > < ≧ ≦) For example, a rule can be triggered if the previous transaction amount is greater than or equal to $1000. In another example, a rule can be triggered if the previous MCC is equal to an automatic fuel pump (MCC=5542). In another example, a rule can be triggered if the previous POS entry mode is equal to a contactless card swipe. In another example, a rule can be triggered if the minutes since the last authorization are less than 20.

A second flash fraud rules aspect may track specific activity totals of a consumer account over a predetermined time period before the payment request. In other words, the occurrences of a type of event may be counted over time. Total counts of a specific activity may be of all authorizations, cash authorizations, merchandise authorizations with cash back, invalid PIN attempts, expiration date mismatches, card verification value (CVV) mismatches, same POS entry mode, same MCC, or unverified ATM deposits. Other event totals are also possible.

Each activity total may regard a rule. A rule may be defined to trigger a fraud indication if the activity total provides a value which satisfies an operator (= ≠ > < ≧ ≦). For example, a rule can be triggered if the total amount of authorizations is greater than 20 over a 24 hour period prior to the transaction. In another example, a rule can be triggered if the total amount of cash authorizations is greater than 10 over a 48 hour period prior to the transaction. In another example, a rule can be triggered if the total amount of merchandise authorizations with cash back is less than 5 over a 48 hour period prior to the transaction. In another example, a rule can be triggered if the total amount of invalid PIN attempts is equal to 1 over a 1 hour period prior to the transaction. In another example, a rule can be triggered if the total amount of expiration date mismatches is not equal to 1 over a 6 hour period prior to the transaction. In another example, a rule can be triggered if the total amount of CVV mismatches is greater or equal to 3 over a 48 hour period prior to the transaction. In another example, a rule can be triggered if the total amount of the same POS entry mode transactions is greater than 7 over a 10 hour period prior to the transaction. In another example, a rule can be triggered if the total amount of the same MCC mode transactions is greater than 5 over a 24 hour period prior to the transaction. In another example, a rule can be triggered if the total amount of unverified ATM deposits is greater than 2 over a 48 hour period prior to the transaction.

A third flash fraud rules aspect may track specific transaction totals of the consumer account over a predetermined time period before the payment request. In other words, the costs of a type of event may be totaled over time. Transactions totals can be of all authorizations, cash authorizations, merchandise authorizations with cash back, invalid PIN attempts, expiration date mismatches, CVV mismatches, same POS entry mode, same MCC, or unverified ATM deposits. Other transactions totals are also possible.

Each transaction total may regard a rule. A rule may be defined to trigger a fraud indication if the transaction total provides a value which satisfies an operator (= ≠ > < ≧ ≦). For example, a rule can be triggered if the total amount of all authorizations is greater than $2000 over a 48 hour period. In another example, a rule can be triggered if the total amount of all cash authorizations is greater than $1000 over a 48 hour period. In another example, a rule can be triggered if the total amount of all merchandise authorizations with cash back is greater than $300 over a 12 hour period. In another example, a rule can be triggered if the total amount of all transactions with invalid PIN attempts is greater or equal to $600 over an 8 hour period. In another example, a rule can be triggered if the total amount of all transactions with expiration date mismatches is less than $2000 over a 48 hour period. In another example, a rule can be triggered if the total amount of all transactions with the same POS entry mode is not equal to $1 over a 1 hour period. In another example, a rule can be triggered if the total amount of transactions with the same MCC is equal to $150 over a 1 hour period. In another example, a rule can be triggered if the total amount of unverified ATM deposits is greater or equal to $1500 over a 48 hour period.

One or more of the attributes of the three major aspects described above can define the flash fraud rules. A method may be configured to deny a payment request if all, one, or a specific plurality of the flash fraud rules are satisfied. A method may also be configured to pass the payment request to the real time filtering rules if all, one, or a specific plurality of the flash fraud rules are not satisfied.

At step 610, real time filtering rules are defined by the server 200(a) for analyzing a payment request. The real time filtering rules can be constructed in the same manner described above with respect to the flash fraud rules, i.e., tracking individual events, specific activity totals, and specific transaction totals of a consumer account, as described above. A method may be configured to deny a payment request, or pass the payment request to a third party fraud analysis system, if all, one, or a specific plurality of the real time filtering rules are satisfied. A method may also be configured to approve the payment request if all, one, or a specific plurality of the real time filtering rules are not satisfied.

The real time filtering rules may apply the same analysis to a transaction as the flash fraud rules, except for the authorization parameters. In one example, the flash fraud rules are configured to pass on a payment request to the real time filtering rules when the authorization total of a consumer account is less than $1000 over a 24 hour period. The real time filtering rules are configured to approve the payment request when the authorization total of the consumer account is less than $500 over the same 24 hour period. It may seem to be more intuitive to configure the flash fraud rules according to parameters of the real time filtering rules, and forego the layered analysis. However, the real time filtering rules are also configured to send the payment request to a third party analysis system if the authorization total is greater or equal to $500 over the 24 hour period, which has greater cost and processing time implications. Accordingly, one benefit of the layered rules is sending fewer payment requests to the third party analysis system. This is described in more detail below.

The real time filtering rules may also apply additional or different rules which are not implemented by the flash fraud rules. For example, the real time filtering rules may apply rules regarding invalid PIN attempts and minutes since last authorization, while the flash fraud rules apply rules regarding authorization counts and authorization totals.

FIG. 4B shows a user interface 615 for defining the flash fraud and real time filtering rules, according to an embodiment of the invention. The user interface 615 may be used by the issuer 50, and supplied by the payment processing network 40. The user interface 615 may be implemented in software on the remote server computer 220 (b) of the issuer 50, communicatively coupled over a network with the server computer 200(a) of the payment processing network 40, as shown in FIG. 2.

The user interface 420 is graphically generated by software on a display device and displays user inputs for creating, updating, and sending flash fraud and real time filtering rule configurations. The flash fraud and real time filtering rules can be uploaded to the server computer 200(a) and/or rule database 200(c), or a remote database of the issuer 50. The user interface 615 may be a secured internet application of the server computer 200(a), and displayable and accessible over the internet 60 on a web browser of the client computer 220(a) of the issuer 50.

The user interface 615 includes a field section 620 for selecting the rule type (flash fraud or real time filtering) to be created or edited using a drop down list as indicated by the drop down symbol “▾”. The field section 620 also includes a field for entering a description of the rule, which in this example is an ATM rule. The field section 620 also includes a field for entering a numerical identifier for the rule, which in this example is a three digit number of 619.

The user interface 615 includes a field section 625 for tracking individual events. A plurality of fields according to the individual event attributes described above is shown. Each field includes a manually enterable value, as single values or ranges of values, or provides predefined drop down values. A plurality of drop down fields according to rule operators (= ≠ > < ≧ ≦) is also shown.

If the event value is satisfied by the chosen rule operator, then the associated payment request may be determined to be indicative of a fraud condition. In this example, the event value aspect of the ATM rule may indicate fraud when the previous transaction type was an ATM transaction.

The user interface 615 also includes a field section 630 for tracking specific activity totals. A plurality of fields according to the specific activity totals described above is shown. 24 and 48 hour activity totals may be entered. A plurality of drop down fields according to rule operators (= ≠ > < ≧ ≦) is also included. If the activity total is satisfied by the operator, then the associated payment request may be indicative of a fraud condition. In this example, the activity total aspect of the ATM rule may indicate fraud when three or more unverified ATM deposits have been made within the previous 48 hours before the payment request.

The user interface 615 also includes a field section 635 for tracking specific transaction totals. A plurality of fields according to the specific transaction totals described above is shown. 24 and 48 hour transaction totals may be entered as single values or ranges of values. A plurality of fields according to rule operators (= ≠ > < ≧ ≦) is also included. If the transaction total is satisfied by the operator, then the associated payment request may be indicative of a fraud condition. In this example, the transaction total aspect of the ATM rule may indicate fraud when more than $1500 in unverified ATM deposits has been made within the previous 48 hours.

The ATM rule may be configured to be triggered by a risk factor in a transaction. For example, factors indicating a high dollar ATM withdrawal from a new card member may intersect a payment request with rule 619. If the card holder's historical transaction records indicate that the previous transaction type was an ATM transaction and three or more unverified deposits totaling more than $1500 have been made in the past 48 hours, then all fraud conditions have been met and the transaction will be denied. Alternatively, the ATM rule 619 may only require that one fraud condition is met to deny the transaction. This is a simple exemplary rule which only uses three possible historical aspects of a consumer account, however, many more aspects can be used.

The user interface 615 also includes a selectable button 640 for updating and sending the flash fraud and real time filtering rules to the server computer 200(a) and/or rule database 200(c). Selecting the button 640 also causes aspects of the method 600 to be executed on the server computer 200(a) or the remote server 220(b) of the issuer 50.

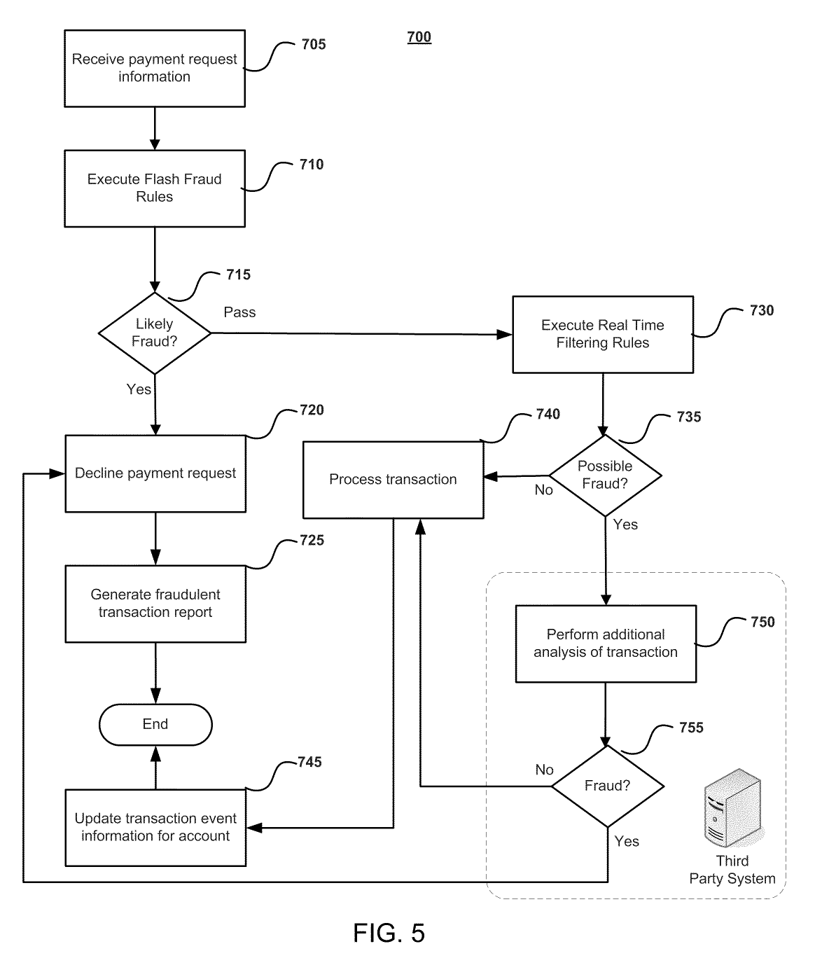

FIG. 5 shows a flow diagram of a method 700 for processing a transaction, according to an embodiment of the invention. At step 705, a payment request for a transaction of a consumer account is received by server computer 200(a). It should be understood that in this example the payment request has already successfully passed one or more standard low level validation tests (e.g., PIN, CVV, CVV2, ATC validation, etc.), which may occur at the payment processing network 40, acquirer 30 or issuer 50 level. However, there may be an indicator of potential fraud present in the transaction, such as triggered risk factors. Accordingly, a higher level of scrutiny is applied to the payment request using method 700.

At step 710, the flash fraud rules are applied. As described above, the flash fraud rules apply certain velocity information of the consumer account and/or current transactional information to specific and relevant fraud rules. The flash fraud rules can analyze many different historical aspects regarding individual events, activity totals, and transaction totals. The server computer 200(a) can access the cardholder database 200(b) to retrieve historical transaction information of the consumer account, or a particular group of consumer accounts, stored in a consumer account profile, and the rules database 200(c) to retrieve the relevant flash fraud rules.

At step 715, it is determined if the historical transaction information and/or current transactional information indicates likely fraud, according to the flash fraud authorization parameters. In this example, the flash fraud authorization parameters have a relatively high authorization threshold. Accordingly, failing the flash fraud authorization parameters is an indication of likely fraud, and will cause the payment request to be declined in step 720. A fraudulent transaction report will then be generated in step 725. Passing the flash fraud authorization parameters is still an indication of a possibly fraudulent transaction, as the flash fraud authorization parameters are only configured to deny likely fraudulent transactions and not approve transactions.

At step 730, the real time filtering rules are applied to the payment request. The server computer 200(a) can access the cardholder database 200(b) to retrieve historical transaction information of the consumer account, or the particular group of consumer accounts, stored in a consumer account profile, and the rules database 200(c) to retrieve the relevant real time filtering rules.

As described above, the real time filtering rules can apply the same analysis as the flash fraud rules, with the exception of the authorization parameters. For example, the flash fraud rules can be configured to pass (i.e., not deny) an ATM withdrawal if less than three unverified ATM deposits totaling less than $3000 were made in the past 24 hours. The real time filtering rules can be configured to approve an ATM withdrawal if less than three unverified ATM deposits totaling less than $750 were made in the past 24 hours. Accordingly, the flash fraud rules can reject likely fraudulent transactions based on historical information, while the real time filtering rules can provide an even higher level of scrutiny to the transaction. The real time filtering rules can also add additional levels scrutiny, for example, additionally requiring that the most previous transaction was not an ATM deposit and no PIN mismatches were detected.

At step 735, it is determined if the real time filtering rules indicate possible fraud, according to the real time filtering authorization parameters. If the transaction does not meet this scrutiny, then additional third-party analysis is applied in steps 750 and 755, such as Falcon® by Fair Isaac Corp. Alternatively, the transaction may be denied at this point. If the transaction meets scrutiny, then the transaction is approved in step 740. In step 745, transaction event data of the consumer is updated to the cardholder database 200(b) to include the events of the processed transaction.

A more intuitive approach may appear to be to only apply the higher scrutiny of the real time filtering rules, and not apply the flash fraud rules. However, removing the flash fraud rules would slow the payment authorization process and provide a lower cost to benefit ratio. The flash fraud rules remove likely fraudulent transactions, which would otherwise need to be processed by a third party fraud detection system. The real time filtering rules only pass possibly fraudulent transactions, and no likely fraudulent transactions, to the third party fraud detection system. Accordingly, under the method 700 fewer transactions need to be scrutinized by a third party fraud detection system. Third party analysis adds transaction costs as well as processing time, as such systems are situated outside of a standard authorization platform. Accordingly, the flash fraud and real time filtering rules provide the issuer 50 with custom configurable fraud rules, which are effective and reduce the need for third party analysis, and which only send relevant transactions to third party analysis. Conventional fraud techniques are not capable of utilizing velocity analysis to filter transactions for third party analysis.

In many embodiments, the flash fraud and real time filtering rules are associated with specific risk factors present in a particular transaction. Such risk factors cause particular flash fraud and real time filtering rules to be applied to the particular transaction, such as the risk factors described in commonly assigned and simultaneously filed U.S. patent application Ser. No. 12/834,793, entitled “Triggering Fraud Rules for Financial Transactions”, Attorney Docket No. 016222-050210US, the entirety of which is incorporated herein by reference.

Embodiments of the invention are not limited to the above-described embodiments. For example, although separate functional blocks are shown for an issuer, acquirer, payment processing system, server computer, or remote server, some entities perform some or all of these functions and may be included in embodiments of invention.

It should be understood that the present invention as described above can be implemented in the form of control logic using computer software in a modular or integrated manner. Based on the disclosure and teachings provided herein, a person of ordinary skill in the art can know and appreciate other ways and/or methods to implement the present invention using hardware and a combination of hardware and software.

Any of the software components, user interfaces, or methods described in this application, may be implemented as software code to be executed by a processor using any suitable computer language such as, for example, Java, C++or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

What is claimed is:

1. A method for processing a transaction, the method comprising:
receiving a payment request to approve a transaction associated with a consumer account at a server computer;
applying at least one fraud rule according to a first authorization parameter to the transaction, using the server computer;
passing the payment request to at least one filtering rule based on approval of the at least one fraud rule, using the server computer;
applying the at least one filtering rule according to a second authorization parameter to the transaction, using the server computer; and
approving the payment request or passing the transaction to third-party fraud analysis based on the application of the least one filtering rule, using the server computer,
wherein the at least one filtering rule applies a transaction attribute of the at least one fraud rule to the second authorization parameter.

2. The method of claim 1, wherein the second authorization parameter is lower than the first authorization parameter.

3. The method of claim 1, wherein the at least one fraud rule and at least one filtering rule analyze historical transaction information of the consumer account.

4. The method of claim 3, wherein the historical information is based on specific events, counts of specific activities, and transaction amount totals.

5. The method of claim 4, wherein the specific events, counts of specific activities, and transaction amount totals are analyzed with respect to a plurality of predefined time periods before the transaction.

6. The method of claim 5, wherein the plurality of predefined time periods include 24 and 48 hour time periods.

7. The method of claim 4, wherein the specific events include one or more of: previous authorization amount, previous MCC, previous POS entry mode, previous transaction type, and minutes since last authorization.

8. The method of claim 4, wherein the counts of specific activities events include counts of one or more of: all authorizations, cash authorizations, merchandise with cash back authorizations, invalid PIN attempts, expiration date mismatches, CVV mismatches, same POS entry mode, and same MCC.

9. The method of claim 4, wherein the transaction amount totals include transaction totals of one or more of: all authorizations, cash authorizations, merchandise authorizations, merchandise with cash back authorizations, invalid PIN attempts, expiration date mismatches, CVV mismatches, same POS entry mode, and same MCC.

10. A server computer, comprising:
a processor for executing instructions of an electronically coupled computer readable medium, the instructions for performing the method of claim 1.

11. A method of generating a fraud rule for a consumer account, the method comprising:
defining transaction attributes applicable to at least one fraud rule and at least one filtering rule regarding a payment request, using a server computer;
defining at least one first authorization parameter for the at least one fraud rule, for authorizing the payment request to pass to the at least one filtering rule and for denying the payment request, using the server computer; and
defining at least one second authorization parameter for the at least one filtering rule, for authorizing the payment request and for passing the transaction to third-party fraud analysis, using the server computer;
wherein the at least one filtering rule applies at least one transaction attribute of the at least one fraud rule to the second authorization parameter.

12. The method of claim 11, wherein the second authorization parameter is lower than the first authorization parameter.

13. The method of claim 11, wherein the transaction attributes are defined by historical information regarding specific events, counts of specific activities, and transaction amount totals.

14. The method of claim 13, wherein the specific events, counts of specific activities, and transaction amount totals are analyzed with respect to a plurality of predefined time periods before the transaction.

15. The method of claim 14, wherein the plurality of predefined time periods include 24 and 48 hour time periods.

16. The method of claim 13, wherein the specific events include one or more of: previous authorization amount, previous MCC, previous POS entry mode, previous transaction type, and minutes since last authorization.

17. The method of claim 13, wherein the counts of specific activities events include counts of one or more of: all authorizations, cash authorizations, merchandise with cash back authorizations, invalid PIN attempts, expiration date mismatches, CVV mismatches, same POS entry mode, and same MCC.

18. The method of claim 13, wherein the transaction amount totals include totals of one or more of: all authorizations, cash authorizations, merchandise authorizations, merchandise with cash back authorizations, invalid PIN attempts, expiration date mismatches, CVV mismatches, same POS entry mode, and same MCC.

19. The method of claim 11, wherein the server computer performs the steps in accordance with received instructions from a remote server computer, the instructions being entered at a user interface coupled to the remote server computer.

20. A server computer, comprising:
a processor for executing instructions of an electrically coupled computer readable medium, the instructions for performing the method of claim 11.
